(19) United States
(12) Patent Application Publication
(10) Pub. No.: US 2015/0108721 A1
(43) Pub. Date: Apr. 23, 2015

(54) PASSIVE SHUTDOWN SEALING DEVICE FOR A SYSTEM OF SHAFT SEALS OF A REACTOR COOLANT PUMP SET

(71) Applicant: AREVA NP, Courbevoie (FR)

(72) Inventor: Romain Thuillier, Valencienns (FR)

(21) Appl. No.: 14/376,101

(22) PCT Filed: Jan. 31, 2013
(86) PCT No.: PCT/EP2013/051928

§ 371 Date: Jul. 31, 2014

(30) Foreign Application Priority Data
Feb. 1, 2012 (FR) 1250957

(51) Int. Cl. F16J 15/18; F16J 15/54; F16J 15/28

(52) U.S. Cl. CPC F16J 15/188; F16J 15/28; F16J 15/54
USPC 277/522; 277/510; 277/540; 277/536; 277/541; 277/535

(57) ABSTRACT

The present invention relates to a passive shutdown sealing device (20) for a reactor coolant pump unit comprising: a split sealing ring (23) having an inactivated position in which a leakage flow is permitted and an activated position in which said ring stops said leakage flow; at least one piston (22) designed to position said split sealing ring (23) in its activated position; locking/unlocking means (25) designed to lock said at least one piston (22) in its inactivated position when the temperature of said locking/unlocking means is below a temperature threshold and to release said at least one piston (22) when the temperature of said locking/unlocking means is above said temperature threshold; elastic means (24) designed to move said at least one piston (22) when said piston is released, so as to position said sealing ring (23) in its activated position.

### TECHNICAL FIELD

The field of the invention is that of reactor coolant pump units of pressurised water nuclear reactors (PWNR).

The invention further relates to a passive shutdown sealing device (SSD) for controlling a primary coolant leakage resulting from a failing system of seals present on the reactor coolant pump unit.

### STATE OF THE ART

Shutdown sealing devices (SSD) have been developed in new generation pressurised water nuclear reactors to cope with a failing system of seals of the coolant pump unit as a result of an accidental situation, called Station Black Out (SBO).

Thus, shutdown sealing devices must, in that accidental situation and after shutdown of the coolant pump, allow a primary coolant leakage resulting from the failing system of seals of the reactor coolant pump unit to be controlled and stopped.

Conventionally, this type of device is activated by an auxiliary source (such as for example a pressurised nitrogen circuit) and triggering is driven by information delivered by the reactor control, in case of losses of the cooling sources of the reactor coolant pump unit.

For the purpose of dispensing with the use of an activation source, it has been developed a passive shutdown sealing device requiring no auxiliary activation system, nor constituting triggering information at the reactor control. Such a passive shutdown sealing device is described in document WO 2010/068615.

### DISCLOSURE OF THE INVENTION

Within this context, the invention aims at providing an improvement of such a sealing device for ensuring activation of the sealing device as well as its good working order during an accidental situation.

For that purpose, the invention provides a passive shutdown sealing device for a system of shaft seals of a reactor coolant pump unit including:
a split sealing ring having an inactivated position wherein a leakage flow is permitted and an activated position wherein said ring stops said leakage flow;
at least one piston designed to position said split sealing ring in its activated position;
locking/unlocking means designed to lock said at least one piston in its inactivated position when the temperature of said locking/unlocking means is below a temperature threshold, and to release said at least one piston when the temperature of said locking/unlocking means is above said temperature threshold;
elastic means designed to move said at least one piston when the latter is released, so as to position said sealing ring into its activated position.

Thanks to the invention, it is possible to stop a primary coolant leakage resulting from the failing system of seals of the reactor coolant pump unit without requiring an auxiliary activation source.

The design of the device according to the invention enables a simplified installation on architectures of the reactor coolant pump units already in service.

Thanks to the device according to the invention, it is also possible to adjust the device to the operating requirements of each type of nuclear reactor by adjusting the auto-activation temperature of the device, and more precisely by modifying the composition of the fusionable element.

The passive shutdown sealing device according to the invention can also have one or several of the characteristics below taken singly or according to any technically possible combinations:
said device is designed to be integrated on a system of shaft seals of a reactor coolant pump unit in use;
said ring includes a chamfered side wall designed to cooperate with a chamfered wall of said at least one piston;
said locking/unlocking means are designed to be mechanically degraded from a temperature threshold between 80° C. and 200° C., advantageously equal to 150° C.,
said sealing ring is made of a polymeric material resisting to temperatures above 300° C.,
said sealing ring is made of PEEK;
said sealing ring is made of composite material with PEEK matrix and glass or carbon reinforcement fibres;
said sealing ring is made of a metal material;
said sealing ring is a composite material formed by a metal core and coated with a material more malleable than said metal core;
said material more malleable than said metal core is a polymer or nickel or silver;
said elastic means are compression coil springs or wave springs or spring washers;
the device includes a plurality of pistons and a plurality of locking/unlocking means distributed about the perimeter of said ring, said pistons and said locking/unlocking means being angularly spaced from each other by a constant angle;
said device includes three pistons and three locking/unlocking means;
said device includes a split collar integrated in said sealing ring and designed to ensure sealing of said device in case of degradation of said ring.

One object of the invention is also to provide a reactor coolant pump unit including:
a system of seals designed to perform a controlled leakage occurring along a leakage path arranged along the pump shaft of the reactor coolant pump unit;
a passive shutdown sealing device according to the invention designed to seal at least partly said leakage path of said system of seals when said system of seals is failing and when said sealing ring is activated, so as to perform a controlled leakage.

### BRIEF DESCRIPTION OF THE FIGURES

Further characteristics and advantages of the invention will appear more clearly from the description thereof given below, by way of indicating and in no way limiting purposes, in reference to the appended figures, wherein:

FIG. 1 illustrates a partial cross-section view of a system of seals of a reactor coolant pump unit;

FIG. 2 illustrates a passive shutdown sealing device according to the invention in its rest position integrated in a system of seals of a reactor coolant pump unit;

FIG. 3 illustrates the shutdown device according to the invention, illustrated in FIG. 2, in its activated position.

For the sake of clarity, identical or similar elements are marked by identical reference signs throughout the figures.

### DETAILED DESCRIPTION OF AT LEAST ONE EMBODIMENT

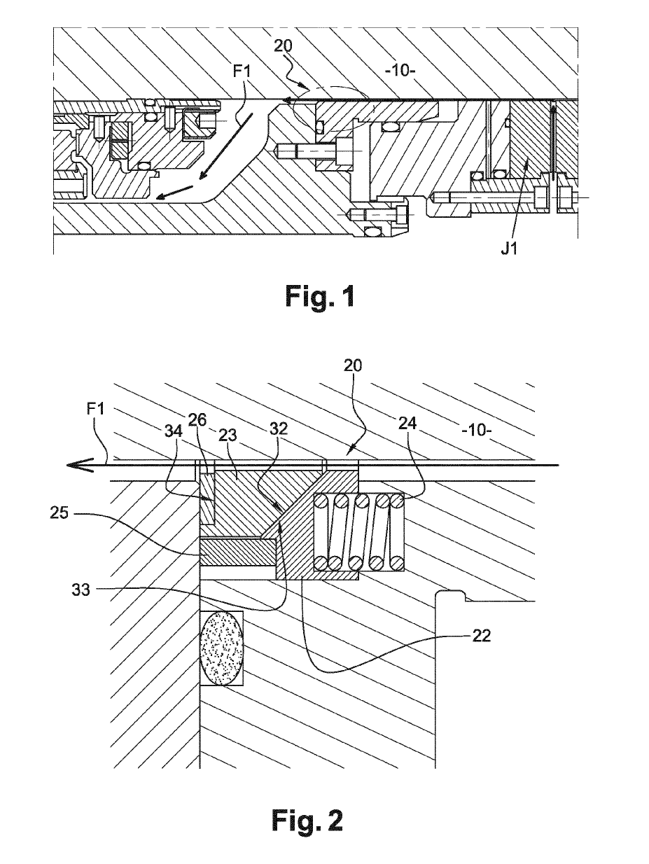

Coolant pumps of pressurised water reactors are of the vertically mounted centrifugal type. Dynamic sealing at the outlet of the shaft 10 (FIG. 1) is ensured by a system of seals consisting of three stages.

The first stage is called seal n° 1. Seal n° 1, reference J1, is a controlled leakage hydrostatic seal. In regular operation, a leakage flow, illustrated by arrow F1, occurs along the shaft 10.

In an accidental situation, the fluid temperature at the inlet of seal n° 1 undergoes a quick temperature rise to reach a value close to the temperature of the primary circuit, that is about 280° C. At this temperature, the performances of seal n° 1 are degraded which causes a very high increase in the leakage flow which can exceed 10 m³ per hour. The passive shutdown sealing devices (SSD) are meant in this accidental situation to block the leakage path F1 downstream of seal n° 1.

FIG. 1 more particularly represents the leakage path F1 along the shaft 10 between seal n° 1 and seal n° 2 (not represented) located upstream of seal n° 1.

Advantageously, the SSD device 20 according to the invention is positioned on the leakage path F1 so as to be capable of blocking the flow of the leakage flow along the shaft 10 in an accidental situation.

FIG. 2 more particularly illustrates the sealing device 20 during regular operating conditions of the reactor coolant pump unit, that is when the temperature of the leakage flow is below a threshold value.

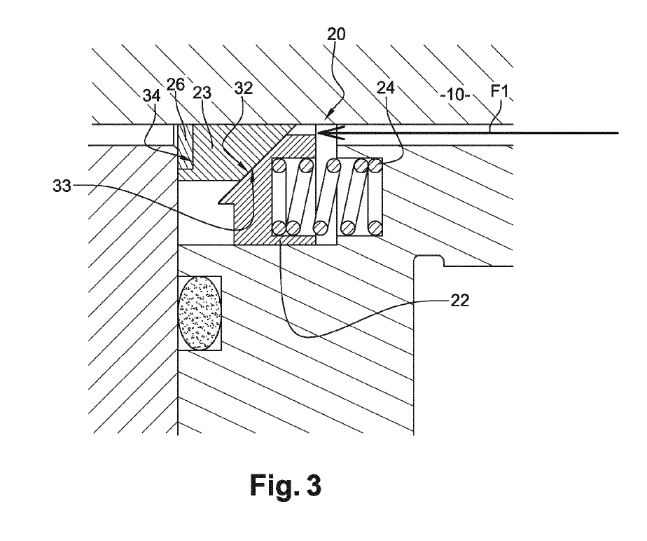

FIG. 3 more particularly illustrates the sealing device during accidental operating conditions of the reactor coolant pump unit, that is when the temperature of the leakage flow is above a threshold value.

The shutdown sealing device 20 according to the invention includes:
a split sealing ring 23 concentrically positioned about the pump shaft 10 of the reactor coolant pump unit;
means 22, of the piston type, designed to restrict the split sealing ring 23 in a position more closed than that corresponding to its operating position wherein the leakage path is not obstructed;
locking/unlocking means 25 formed by a fusionable ring for locking the position of the pistons 22 into a position, called rest position (or inactivate position), when the temperature of the leakage flow is below a predetermined threshold value, and for unlocking the position of the pistons 22 from their rest position so as to reach a position, called activated position, when the temperature of the leakage flow is above or equal to the predetermined threshold value;
elastic means 24, such that for example compression springs, designed to axially move the different pistons 22 of the device 20 so as to axially restrict the split sealing ring 23 about the shaft 10.

The pistons 22 are distributed about the circumference of the sealing ring 23.

The sealing ring 23 has a first chamfered side wall 33 the slope of which is designed to cooperate with the chamfered wall 32 at the lower part of the pistons 22.

The contact between the piston 22 and the split sealing ring 23, and more particularly between the chamfered wall 32 of the piston and the chamfered wall 33 of the sealing ring 23, is ensured by a plurality of elastic means 24, for example compression coil springs, wave springs, spring washers, distributed about the circumference of the sealing ring 23 and exerting a strain onto the piston 22.

According to the embodiment illustrated in FIGS. 2 and 3, the pistons 22 include bores 34 designed to partly or totally accommodate the elastic means 24.

The locking/unlocking means 25 are formed by a polymeric material fusionable ring selected depending on its degradation temperature and its loss of mechanical characteristics from a given temperature threshold.

According to a preferential mode of the invention, the device includes three pistons 22 and three elastic means 24 distributed at 120° on the circumference of the pump shaft 10 of the reactor coolant pump unit.

Under regular operating conditions (FIG. 2), the sealing ring 23 is kept set back from the leakage path F1. The sealing ring 23 is locked into this position by spring return and by pressing against the chamfered wall 32 of the pistons 22, the pistons 22 being kept in their rest position by the fusionable ring 25.

Under accidental conditions (FIG. 3), the increase in the temperature of the leakage flow results in increasing the temperature in the vicinity of the shutdown device 20, and in particular the temperature of the fusionable ring 25. When the temperature of the leakage flow reaches a threshold value, predefined depending on the nature of the fusionable ring 25, the latter is degraded consequently not ensuring any longer a sufficient mechanical strength to resist to the strain generated by the plurality of elastic means 24. The fusion of the fusionable ring 25 upon increasing the temperature thus enables the device 20 to be triggered by unlocking the pistons 22.

Since the pistons 22 are no longer kept in their rest position, the strain exerted by the elastic means 24 axially moves the pistons up to their activated position illustrated in FIG. 2.

The axial movement of the pistons 22 generates a radial strain on the sealing ring 23 via the chamfered wall 32 of the pistons slidingly cooperating with the chamfered wall 33 of the sealing ring 23.

The radial stress, due to the movement of the pistons 23, will generate a reduction in the diameter of the split sealing ring 23 such that this one comes to squeeze against the shaft of the rotor 10.

Thus, in the activated position of the pistons, the sealing ring 23 ensures blocking of the leakage path F1 thanks to the strain exerted by the elastic means 24 and then also by the autoclaving effect induced by the increase in the pressure upstream of the sealing device 20 in the activated position.

According to a non-limiting embodiment of the invention, the sealing ring 23 has, on its second side wall 34, a shoulder designed to integrate a split collar 26, called an anti-extrusion collar. The split collar 26 is designed to optimally ensure sealing of the shutdown device in particular when during an exceptional situation, the temperature is such that the mechanical characteristics of the sealing ring 23 would be degraded.

The choice of the polymer of the fusionable ring 25 is made such that it can resist to the strain exerted by the elastic means 24 up to a temperature threshold between 80° C. and 200° C. and advantageously equal to 150° C.

The sealing ring 23 of the shutdown device 20 can be made of a polymeric material resisting to high temperatures (i.e. above 300° C.) such as for example PEEK or a glass or carbon fibre filled PEEK composite. The use of such a material enables a sealing ring to be obtained at a high temperature in a rubbery state, allowing it to be deformed to perfectly fit the geometry of its environment and thus ensure a better sealing quality.

The split sealing ring 23 of the device 20 can also be made of a metal material. In this case, a residual leakage flow will be expected because of existing clearances between the sealing ring 23 and parts in contact therewith. However, the use of a metal material enables holding the device, in particular the sealing ring to be secured in case of activation of said device before full shutdown of rotation of the pump shaft.

The split sealing ring 23 can also be made of a composite material formed by a metal core coated with a material more malleable than the core, such for example a polymer, nickel or even silver. The peripheral material more malleable than the core will allow existing clearances between the different parts to be filled by deforming the surface layer. In case of wear of the surface layer caused by the shaft rotation, the denser metal core allows a limitation in the leakage flow to be ensured.

The pistons 22 as well as the anti-extrusion split collar 26 are advantageously made of stainless steel type metal materials.

1. A passive shutdown sealing device for a system of shaft seals of a reactor coolant pump unit comprising:
a split sealing ring having an inactivated position wherein a leakage flow is permitted and an activated position wherein said ring stops said leakage flow;
at least one piston designed to position said split sealing ring in its activated position;
locking/unlocking means designed to lock said at least one piston in its inactivated position when the temperature of said locking/unlocking means is below a temperature threshold, and to release said at least one piston when the temperature of said locking/unlocking means is above said temperature threshold;
elastic means designed to move said at least one piston when said piston is released, so as to position said sealing ring in its activated position.

2. The passive shutdown sealing device for a system of shaft seals of a reactor coolant pump unit according to claim 1, wherein said device is designed to be integrated in a system of shaft seals of a reactor coolant pump unit in use.

3. The passive shutdown sealing device for a system of shaft seals of a reactor coolant pump unit according to claim 1, wherein said ring includes a chamfered side wall designed to cooperate with a chamfered wall of said at least one piston.

4. The passive shutdown sealing device for a system of shaft seals of a reactor coolant pump unit according to claim 1, wherein said locking/unlocking means are designed to be mechanically degraded from a temperature threshold between 80° C. and 200° C.

5. The passive shutdown sealing device for a system of shaft seals of a reactor coolant pump unit according to claim 1, wherein said sealing ring is made of a polymeric material resisting to temperatures above 300° C.

6. The passive shutdown sealing device for a system of shaft seals of a reactor coolant pump unit according to claim 1, said sealing ring is made of PEEK.

7. The passive shutdown sealing device for a system of shaft seals of a reactor coolant pump unit according to claim 1, wherein said sealing ring is made of a composite material with PEEK matrix and glass or carbon reinforcement fibres.

8. The passive shutdown sealing device for a system of shaft seals of a reactor coolant pump unit according to claim 1, wherein said sealing ring is made of a metal material.

9. The passive shutdown sealing device for a system of shaft seals of a reactor coolant pump unit according to claim 1, wherein said sealing ring is a composite material formed by a metal core and coated with a material more malleable than said metal core.

10. The passive shutdown sealing device for a system of shaft seals of a reactor coolant pump unit according to claim 9, wherein said material more malleable than said metal core is a polymer or nickel or silver.

11. The passive shutdown sealing device for a system of shaft seals of a reactor coolant pump unit according to claim 1, wherein said elastic means are compression coil springs or wave springs or spring washers.

12. The passive shutdown sealing device for a system of shaft seals of a reactor coolant pump unit according to claim 1, wherein it includes a plurality of pistons and a plurality of locking/unlocking means distributed about the perimeter of said ring, said pistons and said locking/unlocking means being angularly spaced from each other by a constant angle.

13. The passive shutdown sealing device for a system of shaft seals of a reactor coolant pump unit according to claim 1, wherein it includes three pistons and three locking/unlocking means.

14. The passive shutdown sealing device for a system of shaft seals of a reactor coolant pump unit according to claim 1, wherein it includes a split collar integrated in said sealing ring and designed to ensure sealing of said device in case of degradation of said ring.

15. A reactor coolant pump unit comprising:
a system of seals designed to perform a controlled leakage occurring along a leakage path arranged along the pump shaft of the reactor coolant pump unit;
a passive shutdown sealing device according to claim 1 designed to seal at least partly said leakage path of said system of seals when said system of seals is failing and when said sealing ring is activated, so as to perform a controlled leakage.

16. The passive shutdown sealing device for a system of shaft seals of a reactor coolant pump unit according to claim 4, wherein said locking/unlocking means are designed to be mechanically degraded from 150° C.
